(19) United States
(12) Patent Application Publication
(10) Pub. No.: US 2014/0201418 A1
(43) Pub. Date: Jul. 17, 2014

(54) Net-centric adapter for interfacing enterprises systems to legacy systems

(71) Applicants: Thomas G. Turner, King George, VA (US); James Alan Thomas, King George, VA (US)

(72) Inventors: Thomas G. Turner, King George, VA (US); James Alan Thomas, King George, VA (US)

(73) Assignee: United States Government, as represented by the Secretary of the Navy, Arlington, VA (US)

(21) Appl. No.: 13/373,752

(22) Filed: Nov. 14, 2011

(51) Int. Cl. G06F 13/20

(52) U.S. Cl. 710/313

(57) ABSTRACT

A configurable system for translating, exchanging and integrating data and services among disparate software applications is provided. The system includes a first connection that interfaces with an enterprise system, a second connection that interfaces with a legacy system, and an adapter module coupled to the first and second connections. The adapter module is configured to receive data from the first connection and pass data to the second connection. The system may also include a transform module configured to manipulate data received at the second connection. The adapter module may be single-channel or multi-channel. A multi-channel adapter module is able to interface with multiple legacy systems and/or multiple enterprise systems.

### STATEMENT OF GOVERNMENT INTEREST

The invention described herein was made in the performance of official duties by one or more employees of the Department of the Navy, and the invention herein may be manufactured, practiced, used, and/or licensed by or for the Government of the United States of America without the payment of any royalties thereon or therefor.

### BACKGROUND OF THE INVENTION

The current invention generally relates to interaction among one or more legacy systems and one or more enterprise systems, and, more specifically, to an efficiently implemented system and method of interfacing the legacy and net-centric enterprise systems.

There are several technical standards associated with the Internet or World Wide Web that may be leveraged for net-centric military and government systems. Among the key standards are Hypertext Transfer Protocol (HTTP), eXtensible Markup Language (XML), eXtensible Stylesheet Language (XSL), Web Services Description Language (WSDL), Simple Object Access Protocol (SOAP), and Transmission Control Protocol/Internet Protocol (TCP/IP).

Such standards are being leveraged by the Department of Defense (DoD), as articulated in the DoD Information Technology Standards and Profile Registry (DISR), to facilitate systems interoperability across the DoD. (Navy Open Architecture (OA) standards have been subsumed by the DISR.) Many key U.S. allies are following a similar course, as is the U.S. federal government.

Legacy systems present a number of technical challenges to achieving net-centric standards compliance. These issues often include: software architectures, data formats, external interfaces, and constraints of safety and security.

Two mechanisms are frequently used for communications within legacy military software architectures by server and client software applications: (a) Remote Procedure Calls (RPC) made using Application Programming Interfaces (APIs), and (b) the Common Object Request Broker Architecture (CORBA). Both RPC/APIs and CORBA use the TCP/IP for message transmission.

FIG. 1 illustrates a system 100 that uses RPCs over socket-based APIs to support communications between client and server software applications over a network. As shown, the system includes a client application 110 and a server application 120 connected to a common network 130. The client requires a function (or service) 135 to be performed on some data, while the server is able to perform that function 140 (or provide that service).

To initiate this function call, the client uses an RPC 145, employing software “sockets” 150 to remotely call the server function. On the network 130, TCP/IP 155 is used to transmit the function call and provide it on the proper socket 160 to the server. The server recognizes the RPC 165, performs the function 140, and provides the results back to the client.

FIG. 2 illustrates a system 200 that uses CORBA to support communications between client 210 and server (or “object implementation”) 220 software applications over a network 230. CORBA is an object-oriented abstraction layer that utilizes socket-based communications. In the object-oriented paradigm, the calling application invokes a “method” on an object. An Object Request Broker (ORB) 240, which is a software implementation of the CORBA specification, keeps track of the locations of software and objects on the network. It determines the location of a particular implementation and invokes the appropriate method on that object.

Data in a typical legacy system are held in various legacy formats. Often the formats may be custom and proprietary or non-standard conventions. Such legacy data is rarely accessible via standard, net-centric mechanisms (e.g., web services). Accessing and translating legacy data often requires a very large engineering effort

Traditionally, solutions have involved development of point-to-point interfaces. Such interfaces are numerous and essentially proprietary, as they are functional for only a particular pair of systems. Net-centric compliance, however, requires a “many-to-many” data exchange approach that includes a more open approach to defining interfaces, as well as the implementation of various net-centric technical standards (e.g., XML).

Legacy military systems may typically have important safety and security constraints on their design and performance. For example, weapon systems implement various weapon safety requirements, such as maintaining real-time, deterministic, positive control of weapons under all circumstances. The systems may also be affected by issues such as crossing security domains when connecting to the Global Information Grid (GIG) or with other systems with which interfaces are required. One such example is ship systems, where a mixture of multiple security domains exists, due to a variety of classification levels, access authorization, “need to know,” etc.

As a result, radically changing the software architectures of such systems greatly increases risk and invites mission critical failure. Despite great advances in software technologies, current enterprise standards, tools, and implementations are largely unable to meet the most challenging real-time, deterministic requirements of these critical systems.

Current methods and software applications that interface between enterprise and legacy systems have various disadvantages and limitations, including use of manual methods that result in high cost and technical risk, support of only a few types of software interfaces and data formats, limited configuration capabilities to support many different data formats and software interface types, ability to execute on only one or two platforms (e.g., operating systems) and limited scalability. In addition, many software frameworks that implement current methods are focused on the integration of databases via general software application interfaces and have limited extensibility, requiring significant custom programming to extend the data formats, software interface types, etc., that they accommodate. Current methods are also not often concerned with legacy system challenges such as security and safety, do not easily support the development of complex data and software interface adapters, (thus requiring significant custom programming incurring significant cost), do not necessarily lead to automated solutions, do not easily support the creation of a dynamic data association capability, and require adoption of a large, proprietary development environment.

There are two methods typically used to net-enable legacy software applications and/or systems: making extensive manual modifications to the legacy system's source code, or using an enterprise integration application to develop software to access, translate, and integrate data and services among disparate systems. These methods are often used in combination with each other. While these existing tools tend to implement good XML-to-XML data translation capabilities, they provide much less capability for legacy data formats. Using these tools with non-XML, proprietary, legacy data formats requires a significant amount of custom programming.

As can be seen, there is a need for a system and method that makes it possible to translate, exchange, and integrate data and services among disparate legacy software application systems, Systems of Systems (SoS), and enterprise systems. Exemplary systems and methods preferably enable legacy applications and systems to comply with Web/Internet/net-centric technical standards. Further, exemplary systems and methods preferably operate smoothly within various security constraints. Finally, exemplary systems and methods preferably simplify the development of any particular interface.

### SUMMARY OF THE INVENTION

In an exemplary embodiment of the current invention, a configurable system for translating, exchanging, and integrating data and services among disparate software applications includes multiple adapters. Each adapter includes a first connection that interfaces with an enterprise system, a second connection that interfaces with a legacy system, and an adapter module coupled to the first and second connections that receives data from the first connection and passes data to the second connection. In this manner, the system of the present invention facilitates communication between legacy and enterprise systems without requiring uniquely developed components.

In another exemplary embodiment of the current invention, a method of configuring each one of multiple adapters used to interface among multiple systems includes the operations of receiving, through an adapter manager, a selection of an input interface connection type; receiving, through the adapter manager, a selection of a transform type; receiving, through the adapter manager, a selection of an output interface connection type; and configuring an adapter based on the input interface connection type, the transform type, and the output interface connection type. In this manner, the method of the present invention allows a developer to rapidly create customized adapters using a library of standard sub-components.

In another exemplary embodiment of the current invention, a computer readable media for automatically generating adapter source code from existing source code includes a code segment for directing analysis of the existing source code, a code segment for configuring a set of connections within the source code based on the analysis of the existing source code, and a code segment for initiating code generation using a code generation tool, the code generation based on the analysis of the existing source code and configuration of the set of connections. In this manner, the computer readable media of the current invention allows a developer to create an adapter without having to manually analyze existing source code.

These and other features, aspects, and advantages of the current invention will become better understood with reference to the following drawings, description, and claims.

### BRIEF DESCRIPTION OF THE DRAWINGS

FIG. 1 is a block schematic diagram illustrating a prior art system that uses RPCs over socket-based APIs to support communications between client and server software applications over a network;

FIG. 2 is a block schematic diagram illustrating a prior art system that uses CORBA to support communications between client and server (or “object implementation”) software applications over a network;

FIG. 3 is a block schematic diagram conceptually illustrating the net-centric adapter for interfacing enterprise systems to legacy systems (NCALS) software concept according to an exemplary embodiment of the invention;

FIG. 4 is a block schematic diagram conceptually illustrating the “dynamic data association” capability provided by some embodiments;

FIG. 5 is a block schematic diagram conceptually illustrating a software architecture of some embodiments;

FIG. 6 is a flow chart conceptually illustrating a process used by some embodiments to generate an adapter using the adapter manager user interface;

FIG. 7 is a flow chart conceptually illustrating a process used by some embodiments to implement custom connection or transform types;

FIG. 8 is a software layer diagram conceptually illustrating various software layers available to a system where the generic facilities NCALS provides are related to a computing platform and middleware standards;

FIG. 9 is a block schematic diagram conceptually illustrating the data path that may be used to provide (or inject) data to a legacy system;

FIG. 10 is a block schematic diagram conceptually illustrating the data path that may be used to receive (or extract) data from a legacy system;

FIG. 11 is a block schematic diagram conceptually illustrating a simplex connection diagram of some embodiments;

FIG. 12 is a block schematic diagram conceptually illustrating a duplex connection diagram of some embodiments;

FIG. 13 is a block schematic diagram conceptually illustrating a more detailed connection diagram for the simplex scheme described above in reference to FIG. 11;

FIG. 14 is a block schematic diagram conceptually illustrating a more detailed connection diagram for the duplex scheme described above in reference to FIG. 12;

FIG. 15 is a block schematic diagram conceptually illustrating a simplex multi-channel connection diagram 1500 of some embodiments;

FIG. 16 is a block schematic diagram conceptually illustrating a duplex multi-channel connection diagram 1600 of some embodiments;

FIG. 17 is a block schematic diagram conceptually illustrating an example system where NCALS is coupled to a network through a web application server;

FIG. 18 is a block schematic diagram conceptually illustrating an example system that includes components and/or data with a first classification level and other components and/or data with a second classification level;

FIG. 19 is a flow chart illustrating a conceptual process performed by some embodiments to automatically utilize legacy source code to generate adapter source code;

FIG. 20 is a block schematic diagram conceptually illustrating an implementation that integrates an Adapter Creator for Distributed Components (ACDC) with a Source Code Analysis Tool (SCAT) and Code Generation Tool (CGT);

FIG. 21 is a component diagram illustrating various graphical icons that may be used to denote an adapter in the GUI model of some embodiments; and

FIG. 22 is a block schematic diagram conceptually illustrating a computer system with which some embodiments of the invention are implemented.

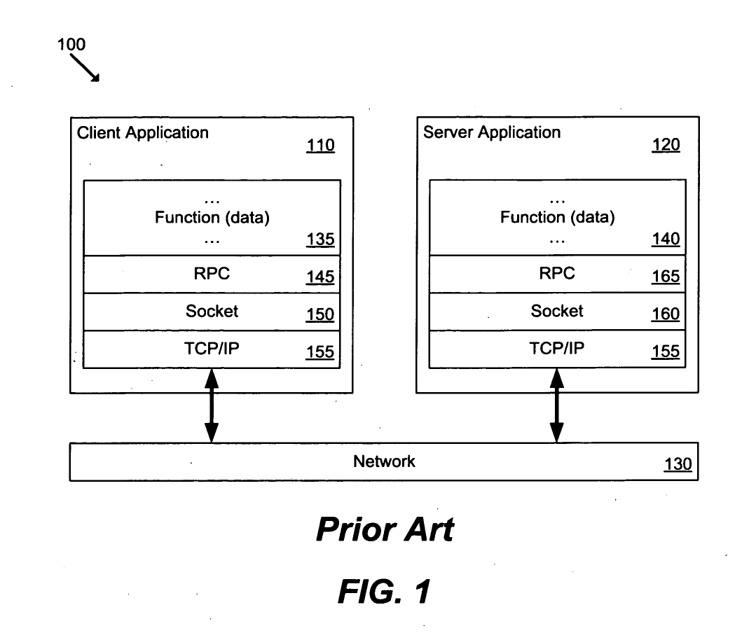

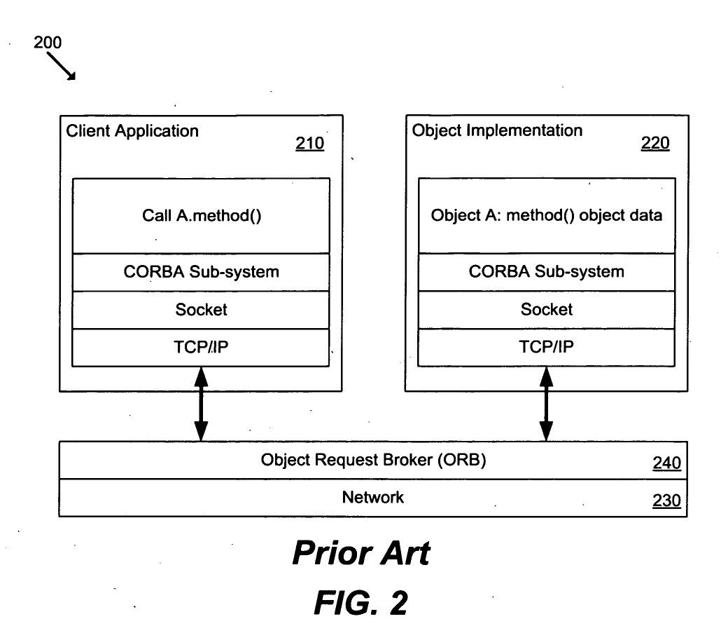

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

In accordance with a presently preferred embodiment of the present invention, the components, process steps, and/or data structures may be implemented using various types of operating systems, computing platforms, computer programs, and/or general purpose machines. In addition, those of ordinary skill in the art will readily recognize that devices of a less general purpose nature, such as hardwired devices, or the like, may also be used without departing from the scope and spirit of the inventive concepts disclosed herewith. General purpose machines include devices that execute instruction code. A hardwired device may constitute an application specific integrated circuit (ASIC) or a floating point gate array (FPGA) or other related component.

Some embodiments of the invention generally provide a highly configurable and automated method, architecture (apparatus), and software application (system) for translating, exchanging, and integrating data and services among disparate software applications, systems, Systems of Systems (SoS), and enterprises. The invention may be applicable to a wide variety of issues in the Department of Defense (DoD), the government, and the commercial sector. For instance, the current invention may be able to reduce the difficulty, cost, risk, and schedule required to make military and government legacy systems comply with net-centric technical standards and the GIG (and/or other network); reduce the difficulty, cost, risk, and schedule required to make commercial legacy systems comply with Web/Internet-based technical standards and to support enterprise integration; reduce the difficulty, cost, risk, and schedule of integrating legacy software applications, systems, SoS, and enterprises; and reduce the difficulty, cost, risk, and schedule of accessing, translating, and integrating data held in disparate formats among heterogeneous software applications, data sources, and systems.

A “legacy system” refers to a method, technology, computer system, or software that continues to be used even though newer technology and/or more efficient methods of performing a task may be available. A legacy system may use communication protocols (and/or other specific features) that may hinder communication with newer technology. An “enterprise system” refers to large-scale, integrated application-software packages that use the computational, data storage, and data transmission power of modern information technology to support business process, information flows, reporting, and data analysis within and among complex organizations.

An exemplary embodiment of the current invention, also referred to as a Net-Centric Adapter for Legacy Systems (NCALS), may be applied to many different application domains, and is not specialized for (or limited to) any particular application domain. The NCALS software is portable across a wide variety of computing platforms (e.g., across operating systems). NCALS is highly extensible, thus readily supporting extension to data formats, software interface types, etc. NCALS is also designed to be highly scalable. This allows NCALS to support the performance requirements of many different systems in many different domains.

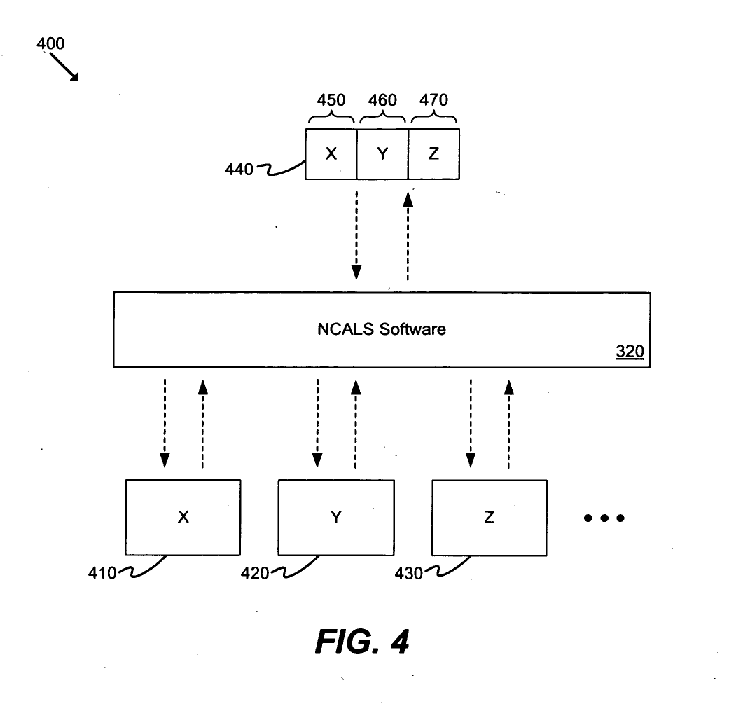

NCALS is also specifically designed to address legacy system challenges and provide built-in support for developing complex data and software interface adapters, thus reducing software development costs. NCALS is specifically designed to generate a highly automated solution and easily support the creation of a dynamic data association (DDA) capability. DDA is described in more detail below in reference to FIG. 4. NCALS minimizes and often completely eliminates changes to legacy system source code otherwise required to participate in a net-centric/web-based environment. In addition, NCALS is designed and implemented as a common, generic software component that may be used by many different legacy systems. Such adaptability results in cost savings.

In addition, NCALS operates as a “lightweight” software component. That is, NCALS does not require a system developer to adopt a large, monolithic, and proprietary software framework. The developer may use NCALS where it fits best without extra baggage. Thus the developer may more easily change the system framework to meet changing domain mission requirements while still using NCALS where it is most applicable.

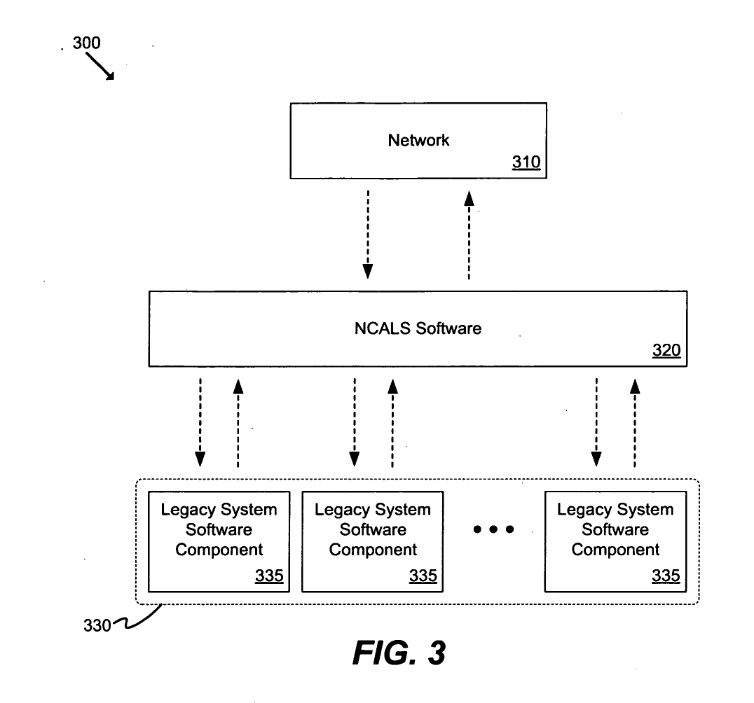

FIG. 3 illustrates the NCALS software concept 300 according to an exemplary embodiment of the invention. Specifically, this figure shows the use of NCALS to interface among a network 310 and various legacy system software components. As shown, the concept includes the network for providing information to and receiving information from users (the network may be an IP-based network), the NCALS software 320 for interfacing among legacy and enterprise systems, and a legacy system 330 for delivering some particular functionality having various software components 335.

NCALS 320 may serve as an automated, two-way gateway between the legacy system 330 and the network 310. As such, NCALS may operate in an automated fashion to expose data from legacy systems to users of the network. In addition, NCALS may be configurable, as a common software component, to support a variety of legacy systems, as well as to be portable across a variety of computing platforms. Furthermore, the NCALS architecture may be scalable to accommodate the net-centric data requirements of many different legacy systems. A legacy system includes legacy software components running on hardware, typically on a Local Area Network (LAN). These software components communicate with one another via legacy software interfaces (e.g., APIs, CORBA, etc.) and store data in legacy formats.

The NCALS software may use existing legacy software interfaces to obtain legacy data, transform it into net-centric standard formats, and publish it to the network in compliance with net-centric standards. Likewise, NCALS may transform network data into legacy data formats and deliver the data to the legacy system via its existing software interfaces.

Regardless of the particular domain, data, and services of a legacy system, much of the NCALS functionality may be common. However, NCALS is configurable to accommodate the specifics of a particular legacy system operating in its specific domain of operations.

Because NCALS is designed to enable net-centric operations, NCALS focuses on enabling legacy systems to interoperate with the GIG, Internet, and/or other networks. As a result, NCALS provides a service-oriented architecture connection for a legacy system to the rest of the enterprise on the network. However, NCALS does not modify the legacy components to comply internally with the net-centric technical standards. Thus, NCALS allows the legacy system architecture to remain largely undisturbed.

FIG. 4 illustrates the DDA capability 400 provided by some embodiments. This capability enables adapters to mix and match data from multiple software components or systems dynamically (or “on the fly” during execution) to form new messages in a new format. Likewise, data can be disassembled, filtered, transformed, and provided to the legacy systems or components in formats that the legacy systems understand. This data can be injected into disparate interfaces (e.g., a CORBA interface and a socket-based API) of the legacy systems or components.

An “adapter” of some embodiments may generally include a collection of software components that allows one or more systems (or components) to communicate with one or more other systems or components. Such communication may include data communication (e.g., sending and/or receiving of data) and/or software communication (e.g., passing one or more sets of instructions that cause a particular system or component to execute some functionality). Throughout the current application the term “adapter” may be used to refer to the collection of software components described above as well as particular sub-components within the collection. In addition, one of ordinary skill in the art will recognize that an adapter could be implemented using hardware rather than software (e.g., by implementing a set of circuitry that provides the necessary signal processing).

As shown in the example of FIG. 4, three legacy software components 410-430, each holding different but related data elements, communicate with each other over an IP-based network. NCALS 320 may be able to create an adapter that takes this data, repackages it together, and provides it to an enterprise network in a net-centric data format 440. Such repackaged data may include representations of the elements 450-470 provided by the various components 410-430.

Likewise, NCALS is able to create an adapter that may receive a message 440 in a net-centric data format, provided via a modern software interface (e.g., web services, or the Data Distribution Service), and transform and distribute the appropriate data elements 450-470 to the appropriate legacy software components 410-430.

NCALS is a generic, highly configurable software toolkit/library consisting of a number of software components and utilities designed to support a Legacy System Developer (LSD) as the developer integrates software applications, components, and/or systems. These software components can be arranged and extended in a number of different ways to achieve the best results for a particular application while maintaining an extensible, configurable, and scalable solution.

Several more detailed embodiments of the invention are described in the sections below. Section I provides a conceptual description of the NCALS software architecture. Next, Section II provides an overview of various NCALS implementation considerations. Section III describes generation of various NCALS components, including adapters, connections, and transforms. Section IV then describes the relationship of various software layers used by NCALS. Next, Section V describes various data transmission paths used by NCALS. Section VI then describes several connection schemes that may be used when implementing NCALS. Section VII describes using NCALS with separate networks and/or various security measures. Section VIII then describes an adapter creator for distributed components. Lastly, Section IX describes a computer system which implements some of the embodiments of the invention.

### I. NCALS System Architecture

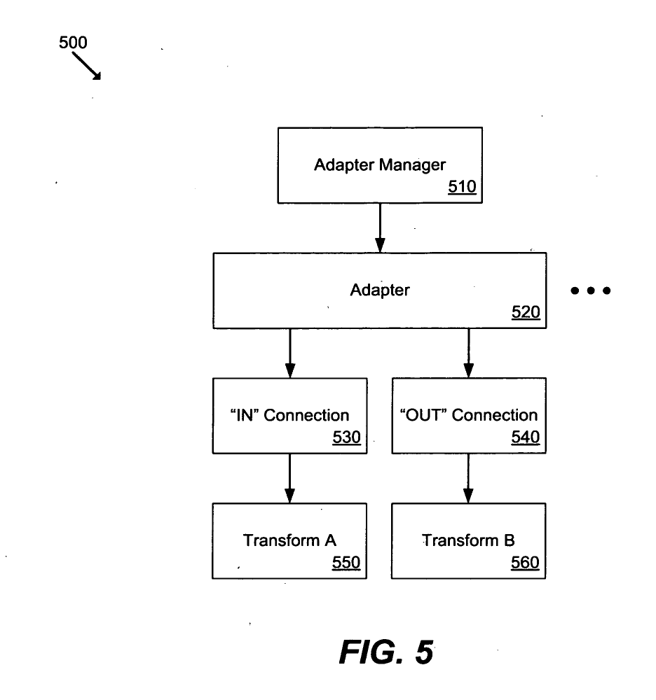

NCALS has three major abstractions: the adapter, the connection, and the transform. Two of the abstractions (typically the connection and transform) should be specialized for each legacy system implementation. FIG. 5 illustrates a software architecture 500 of some embodiments. As shown, the software includes an adapter manager 510 for creating and managing one or more adapters 520, each adapter for interfacing among a set of connections. The adapters may often be implemented as multiple instances within a single Java Virtual Machine (JVM). The software also includes a set of connections 530-540 for interfacing among a set of systems, and a set of transforms 550-560 for transforming data among disparate formats.

Each adapter 520 may manage logic and data flow between “IN” and “OUT” connection instances 530-540 by registering with each connection and listening for or sending data to a peer connection. Connections manage the input/output (I/O) details and resources of a data source or sink. Each connection component may have an associated transform 550-560, which converts or mutates data into a desired format. When a particular connection instance does not need to transform data, a “Null” transform is provided as a placeholder that simply passes the data without modification.

### II. NCALS Implementation Considerations

The community of users that NCALS targets consists of Legacy System Developers (LSDs) who have a mandate or have otherwise been tasked with conforming systems interfaces and/or data to an enterprise standard such as web services, XML, Data Distribution Service (DDS), or other SOA-enabling standards. Situations exist where a legacy system's source code cannot be modified, such as for security, sensitivity, data rights, or cost reasons. In those cases, a configured NCALS Adapter can co-exist on the same network or even the same hardware as the legacy system and connect and transform that legacy system's data and service to the enterprise.

The LSD should begin to address the middleware needs by understanding the Legacy System interfaces that are to be exploited. The type of interface (CORBA, TCP/IP or User Datagram Protocol (UDP) Socket, Java Message Service (JMS), Web Service, File I/O, URL over HTTP, RSS* feed, email, etc.) as well as the legacy data format (proprietary byte-oriented, object formats, XML, flat file, Comma Separated Values (CSV), etc.) should be determined. The LSD should also assess the frequency of message traffic into or out of these interfaces as well as the message sizes involved. These data points will influence future design decisions with respect to scalability and load balancing.

### III. Adapter, Connection, and Transform Generation

After determining the various system requirements as described above, the LSD proceeds by building a specialized software layer on top of the foundational components provided by NCALS (adapter, connection, and transform components). The transform and connection specializations may proceed as separate software development efforts because, given that they implement the software contract specified by the NCALS components' interface definitions, they are “pluggable” and data transformation details and connection details are separately encapsulated within the NCALS framework. Almost all of the LSD's efforts will be concentrated on the various specializations of transform and connection components because the generic adapter is designed to operate with any such compliant component.

The adapter manager of some embodiments may be a Java implementation (or other appropriate implementation) of a user interface that enables various functions. Such functions may include the creation of one or more adapter instances, dynamic plug-in of existing connection and/or transform types, dynamic plug-in of foreign connection and/or transform types, adapter configuration, definition of adapter connection(s) and any associated transform instances, enablement or disablement of one or more adapter instance(s), and/or logging of traffic through each adapter.

In some embodiments, the adapter manager may provide a graphical user interface (GUI) based design environment for generating adapters. Such an adapter manager may also integrate NCALS with a Source Code Analysis Tool (SCAT) and/or an Integrated Development Environment (IDE) for software. One example of such an adapter manager is described in more detail below in Section VIII.

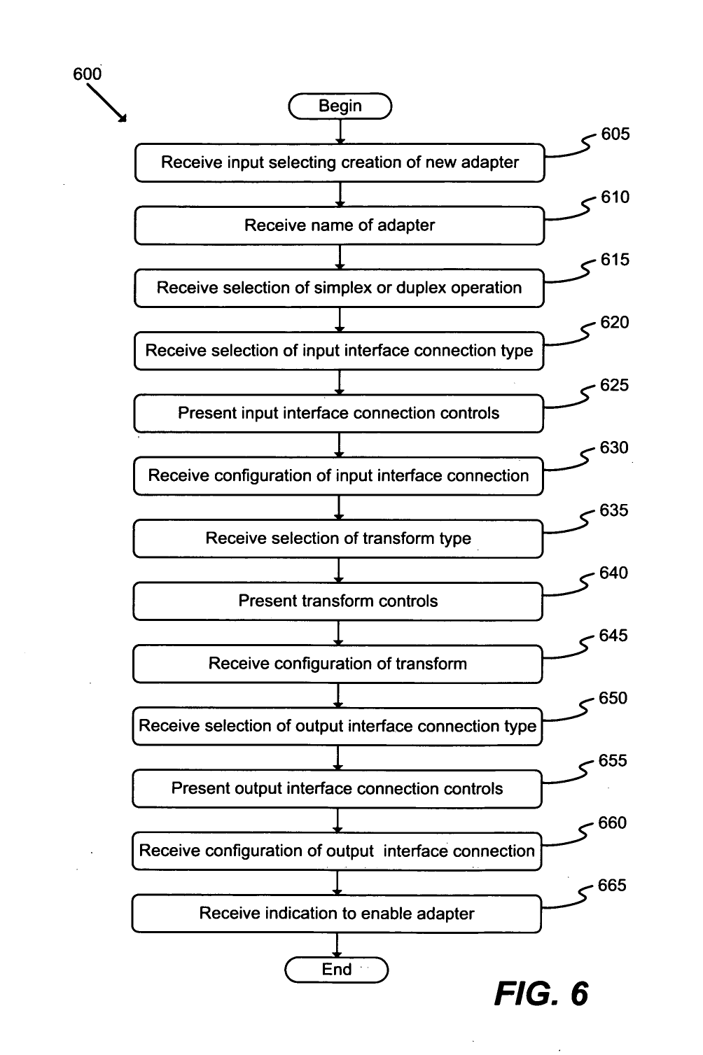

FIG. 6 illustrates a process 600 used by some embodiments to generate an adapter using the adapter manager user interface (or other appropriate way of defining the parameters used to generate an adapter). The process begins when the adapter manager user interface is launched. Next, the process receives (at 605) an input selecting creation of a new adapter (e.g., by selecting “File—New Adapter” from a pull-down menu). The process then receives (at 610) the name of the adapter before receiving (at 615) a selection of simplex or duplex operation to indicate whether traffic will be received and transformed on a return path. Next, the process receives (at 620) a selection of an input interface connection type (e.g., File, TCP, JMS, custom, etc.). The process then presents (at 625) input interface connection controls, which may be provided in an input interface panel or other appropriate way of presenting such controls. The process then receives (at 630) configuration parameters for the input interface connection. The operation of the input interface connection may be at least partially based on the configuration parameters.

Next, process 600 receives (at 635) a selection of transform type (e.g., no Transform, XSLT, custom, etc.). Such a selection may be made, for example, using a drop-down list in a transform panel. The process then presents (at 640) transform controls in a transform panel and receives (at 645) transform configuration parameters. Next, the process receives (at 650) a selection of output interface connection type (e.g., file, TCP, JMS, custom, etc.) before presenting (at 655) output interface connection controls and then receiving (at 660) output interface configuration parameters through an output interface panel. The operation of the output interface connection may be at least partially based on the configuration parameters. The process then receives (at 665) an indication to enable or disable the adapter (e.g., by receiving an indication of “Enable” by the user clicking a check box).

Although process 600 has been described with reference to various details (e.g., receiving a selection of an input interface type), one of ordinary skill in the art will recognize that the process may be implemented in various different ways without departing from the spirit of the invention (e.g., defaulting to a particular input type). In addition, although the process has been described as a continuous set of operations, the process may be implemented in different ways in different embodiments (e.g., operations may be performed in a different order, only a sub-set of operations may be performed, the process may be performed as a sub-process of another process, etc.).

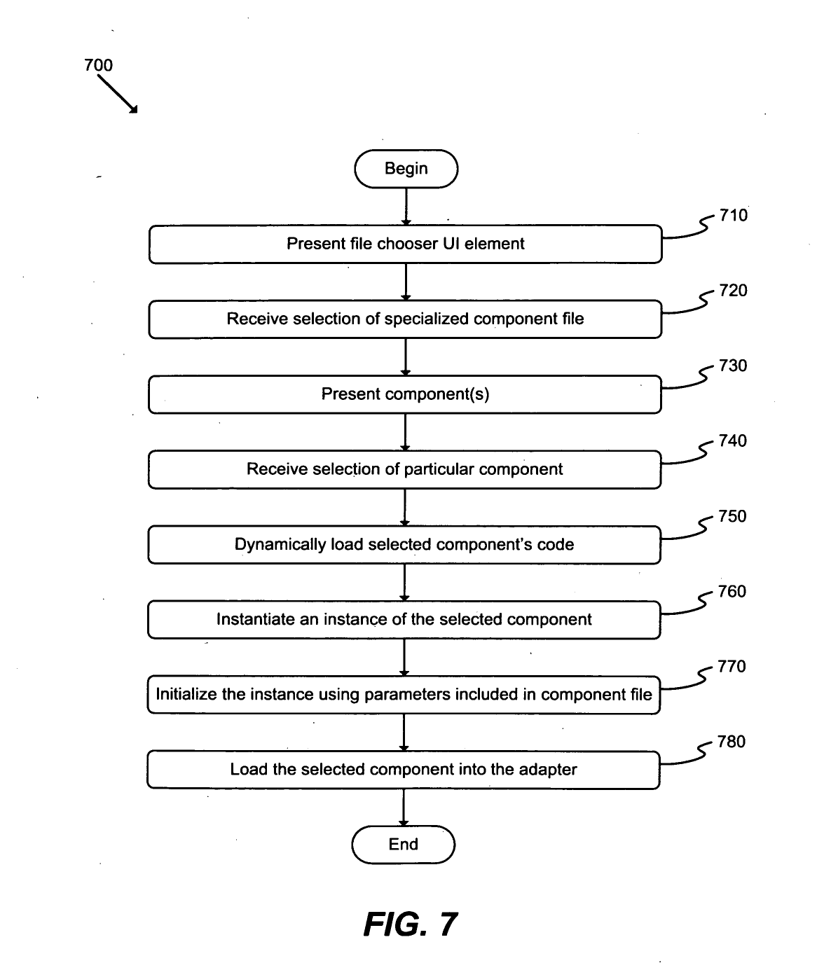

When selecting either a custom connection type or custom transform type (e.g., at operations 620, 635, and/or 650 described above), various internal operations may be performed by the adapter manager to dynamically load and deploy those components. FIG. 7 illustrates a process 700 used by some embodiments to implement such operations. The process begins when a user selects a custom connection or transform type. Next, the process presents (at 710) a file chooser user interface (UI) element. The process then receives (at 720) a selection of a specialized component file. In some embodiments, the file may be a Java ARchive (JAR) file that includes both compiled Java code (or other appropriate code) representing a specialization of the NCALS connection or transform component as well as a “.props” file properly formatted and including configuration information for bootstrapping the initialization of the component to be loaded.

The process then presents (at 730) the components included in the JAR file. A drop-down list of components that are included within the chosen JAR file may be displayed to the user. The user then may select a particular component from the list to be loaded. The process then receives (at 740) a selection of a particular component before dynamically loading (at 750) the selected component code (e.g., by loading the selected component's compiled Java code into a JVM).

The process then instantiates (at 760) an instance of the selected component before initializing (at 770) the instance using parameters included in the component file (e.g., a “.props” file included within the JAR file). The process then loads (at 780) the selected component into the adapter being generated.

Although process 700 has been described with reference to various details (e.g., presenting a list of components), one of ordinary skill in the art will recognize that the process may be implemented in various different ways without departing from the spirit of the invention (e.g., receiving a component selection via a pre-defined datastream). In addition, although the process has been described as a continuous set of operations, the process may be implemented in different ways in different embodiments (e.g., operations may be performed in a different order, only a sub-set of operations may be performed, the process may be performed as a sub-process of another process, etc.).

By permitting properly conforming specializations to be dynamically loaded, instantiated, and configured, adapters can be created by plugging in novel connection and transform types. This allows for extensibility and configuration of user-developed components that exist on top of an NCALS software layer.

### IV. Software Support and Interaction

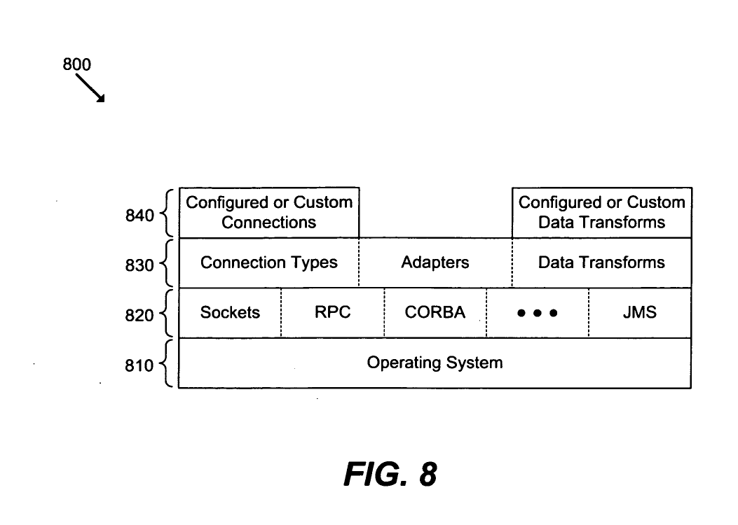

FIG. 8 illustrates a conceptual diagram of various software layers available to a system 800 where the generic facilities NCALS provides (and/or any extensions to those capabilities) are related to a computing platform and middleware standards. As shown, the system includes a platform layer 810 (e.g., an operating system) for managing computer hardware resources and providing common services for execution of various application software, a middleware layer 820 (e.g., various sockets, RPC, CORBA and/or JMS, etc.) for implementing limited resource functionality, an NCALS generic facilities layer 830 for providing connections, adapters, and/or data transforms, and a domain layer 840 for providing various configured and/or custom connections and/or transforms for various specific applications.

NCALS may also support additional middleware, software interface types, and/or data formats. For instance, some embodiments may include library support for software interface types such as the Representational State Transfer (REST), DDS, and SOAP-based web services. DDS is a publish/subscribe middleware designed to simplify programming of distributed systems and to support the requirements of real-time systems. DDS is of particular interest to the military for use in real-time, mission-critical systems. Some embodiments may also add support for additional data formats, such as the JavaScript Object Notation (JSON), a lightweight data-interchange format.

In addition, NCALS may be extended to support one or more military-specific data links (e.g., the “Link 16” tactical data link) and associated messages that may be used for particular data exchanges. Furthermore, NCALS may provide support for additional military and commercial interface standards (e.g., MIL-STD-1553 interfaces used in military aircraft avionics systems, serial interfaces such as the Naval Tactical Data System (NTDS) interface variants, or variations of the RS-232 interface, etc.).

As another example, NCALS may support UDP interaction, as voice, audio, video, and/or other streaming data is generally transferred using UDP via TCP. NCALS support of UDP may allow the creation of adapters among real-time video and audio streaming and may also support the association of metadata with such streaming data. As yet another example, NCALS may support database interface standards, for example Structured Query Language (SQL), and/or legacy database interfaces and/or formats.

Support of these additional middleware, software interface types, data formats, and/or other elements may be provided using plug-ins or other appropriate ways.

### V. Data Transmission

A standard connection does not typically transform data itself when used in the context of an adapter of some embodiments of the present invention. The adapter listens to any associated connection instances, and when an associated connection receives data, that data is transformed and sent on its peer connection. The adapter transforms data when the data is sent on a connection using that connection's transform. However, specialized standalone “adapterless connections” may be able to transform data upon receipt (i.e., generate replies). Once again, upon the reception of data, connections optionally transform (as stand-alone entities) and then forward the data to any registered connection listeners. The adapter “listens” to the connection instances that it manages and forwards those messages on to the peer connection where the data is transformed and sent.

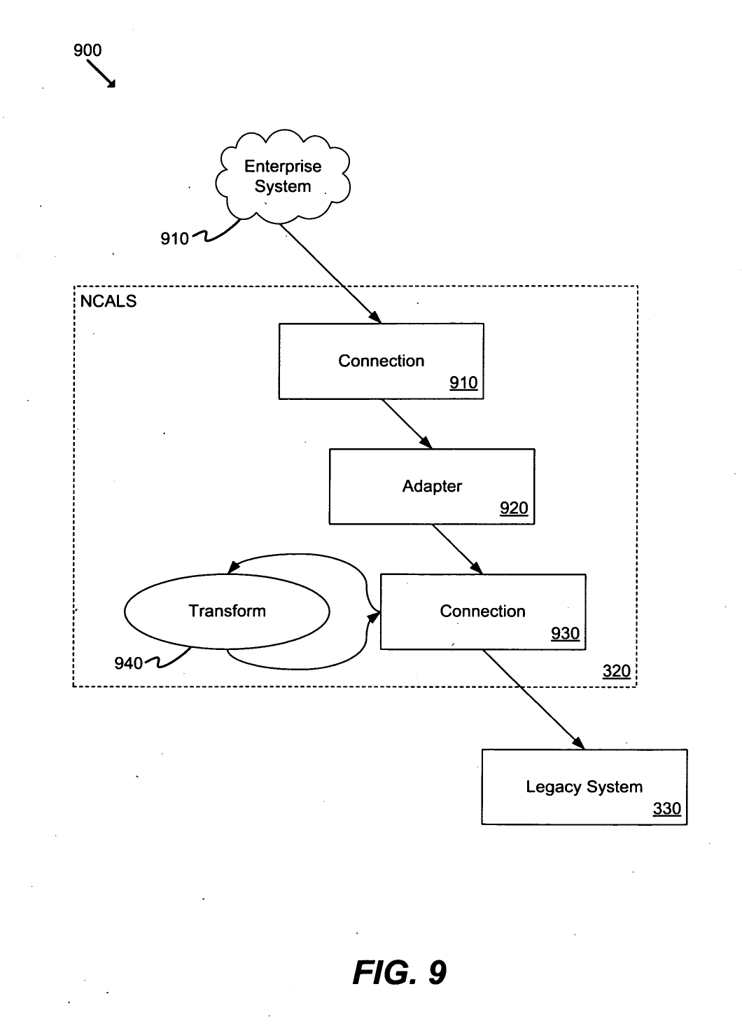

FIG. 9 illustrates the data path 900 that may be used to provide (or inject) data to a legacy system. Specifically, this figure shows the path from an enterprise system 910 (typically providing XML or other such data) to a legacy system 330. As shown, the path includes an enterprise system 910 for accessing and/or manipulating data, a first connection 910 for passing data from the enterprise system to an adapter 920 and notifying the adapter of an incoming message, the adapter for forwarding messages to a second connection 930. The second connection may be configured to transform the data included in any received message to a legacy system 330 (in an appropriate format), where the second connection has an associated transform 940 for manipulating the data received and passed by the second connection, and an interfaced legacy system 330 for receiving data from the second connection, where the second connection may invoke an existing legacy interface and/or write data to a file system used by the legacy system.

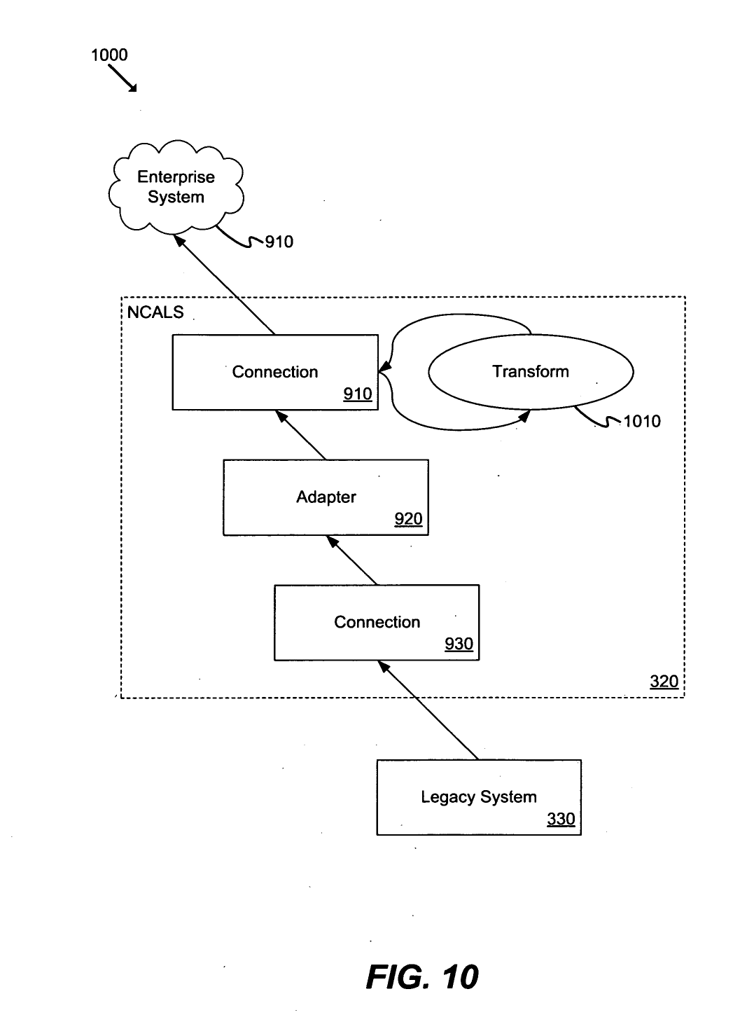

FIG. 10 illustrates the data path 1000 that may be used when receiving (or extracting) data from a legacy system. Specifically, this figure shows the path from a legacy system 330 to an enterprise system 910. As shown, the path includes the second connection 930 described above for receiving data from the legacy system and passing the data to the adapter 920. The data may then be passed to the first connection 910. The first connection may be configured to transform the data included in any received message to an enterprise system (in an appropriate format), where the first connection has an associated transform 1010 for manipulating the data received and passed by the first connection, and where the first connection may invoke an enterprise interface and/or write data to a file system used by the enterprise system.

In addition to the data paths 900 and 1000 described above in reference to FIGS. 9 and 10, NCALS may be able to integrate multiple legacy systems with each other (e.g., where the different legacy systems use different data formats). NCALS also be able to integrate multiple enterprise systems with each other. For instance, multiple enterprise systems that all use XML may be integrated using NCALS when the different systems use different XML structures for exchanging data.

### VI. Connection Schemes

NCALS provides a generic connection component that may be configured in various different ways, as needed. Sub-section VI.A, below, describes “one-way” (i.e., simplex) and “two-way” (i.e., duplex) connection types. Sub-section VI.B then describes multiple channel connectors (MCCs). Several such example connection schemes will be described below. Next, sub-section VI.C describes blocking and non-blocking MCCs. Sub-section VI.D then describes various implementation strategies that may be used to optimize the performance of NCALS. Lastly, sub-section VI.E describes the use of hosted adapter instances to facilitate scalability, administration, and redundancy.

A. Simplex and Duplex Connections

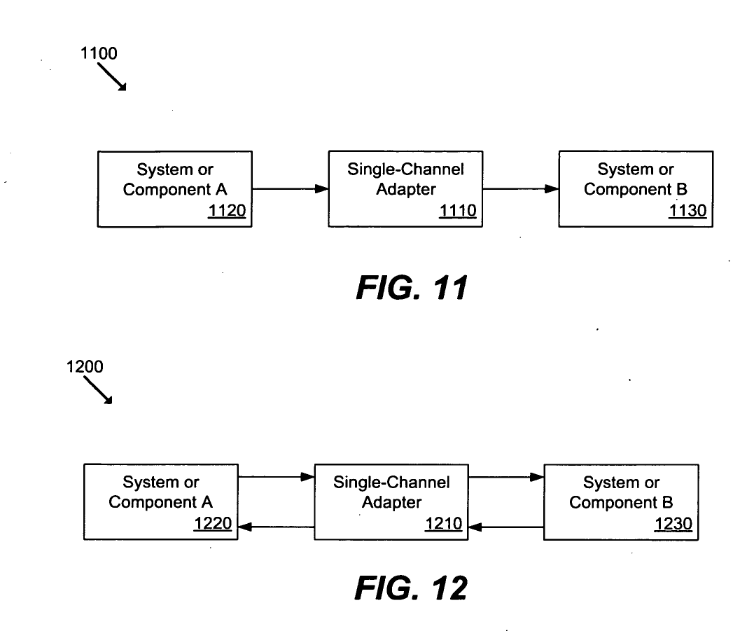

FIG. 11 illustrates a conceptual simplex connection diagram 1100 of some embodiments. As shown, a single-channel adapter 1110 is connected to a first system or component 1120 and a second system or component 1130. In such an implementation, data may arrive (having been either sent or received) from the first system or component and depart (being either received or sent) to the second system or component. Such data may also be transformed between arrival and departure (transform not shown).

FIG. 12 illustrates a conceptual duplex connection diagram 1200 of some embodiments. As shown, a single-channel adapter 1210 is connected to a first system or component 1220 and a second system or component 1230. In such an implementation, data may be sent and received along the same channel, either synchronously or asynchronously. Such a configuration may require non-null transforms assigned to both the “IN” and “OUT” connections of the adapter.

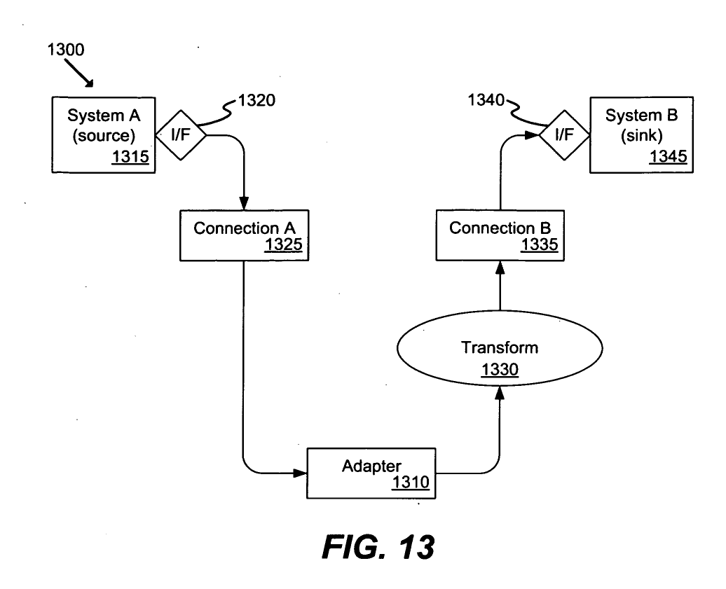

FIG. 13 illustrates a more detailed conceptual connection diagram 1300 for the simplex scheme 1100 described above in reference to FIG. 11. As shown in FIG. 13, the one-way (simplex) implementation 1300 includes an adapter 1310 (which is a sub-component of the adapter 1110), a source system 1315 for supplying data to the adapter 1310, a first interface 1320, a first connection 1325, a transform 1330, a second connection 1335, a second interface 1340, and a sink system 1345 for receiving data from the adapter.

The source system may supply data to the first interface, which, in turn, provides the data to the first connection which receives the data. The adapter subscribes to the connections and transfers data from the first connection to the transform. The transform performs a transformation of the data, if necessary, and provides the data to the second connection. The second connection provides data to the second interface, which, in turn, provides the data to the sink system.

In some instances, NCALS may allow configuration to comply with legacy interface constraints. For example, NCALS may constrain interface characteristics that may impact the performance of a legacy system. Such constraints may include data transfer rate or message size. In addition, a legacy system's interface may be modified to provide an indication to NCALS that, for example, the data transfer rate should be reduced.

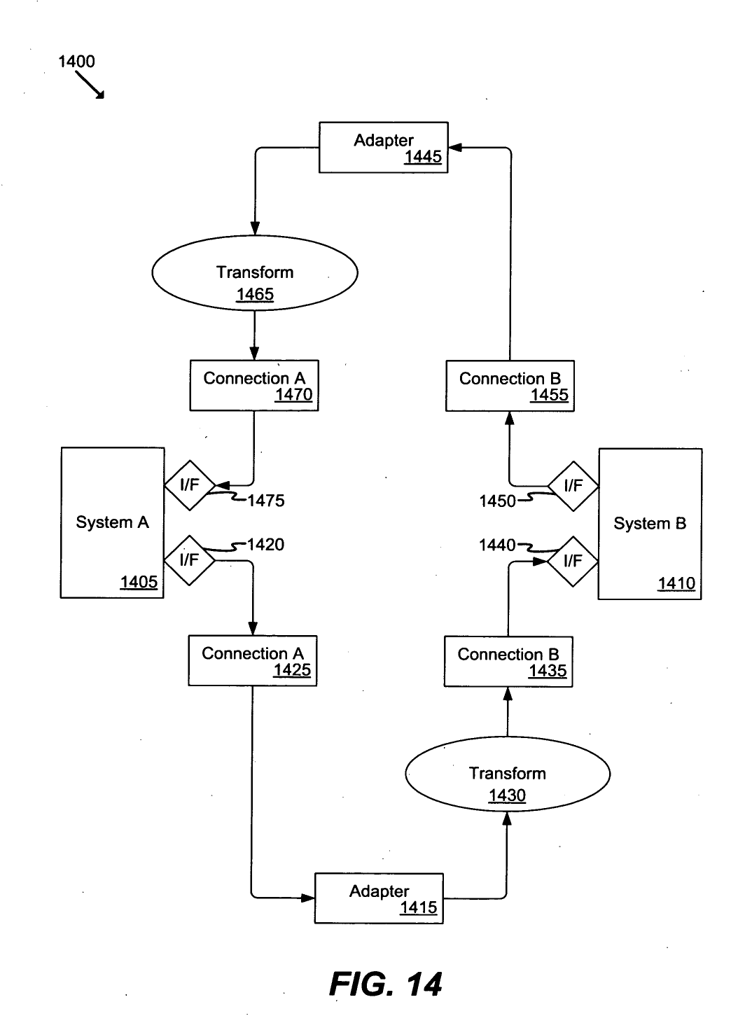

FIG. 14 illustrates a more detailed conceptual connection diagram 1400 for the duplex scheme 1200 described above in reference to FIG. 12. As shown in FIG. 14, the two-way (duplex) implementation 1400 includes two paths connecting a first system 1405 to a second system 1410. The first path may include an adapter 1415 (which is a sub-component of the adapter 1210), a first interface 1420, a first connection 1425, a transform 1430, a second connection 1435, and a second interface 1440. The second path may include an adapter 1445 (which is a sub-component of the adapter 1210), a first interface 1450, a first connection 1455, a transform 1465, a second connection 1470, and a second interface 1475. The first system 1405 may pass data along the first path in a similar way to that described above in reference to FIG. 13.

Returning to FIG. 14, the second system 1410 may pass data along the second path by receiving data through the first interface 1450, which, in turn, provides the data to the first connection 1455 which receives the data. The adapter 1445 subscribes to the connections and transfers data from the first connection to the transform 1465. The transform performs a transformation of the data, if necessary, and provides the data to the second connection 1470. The second connection provides data to the second interface 1475, which, in turn, provides the data to the first system 1405.

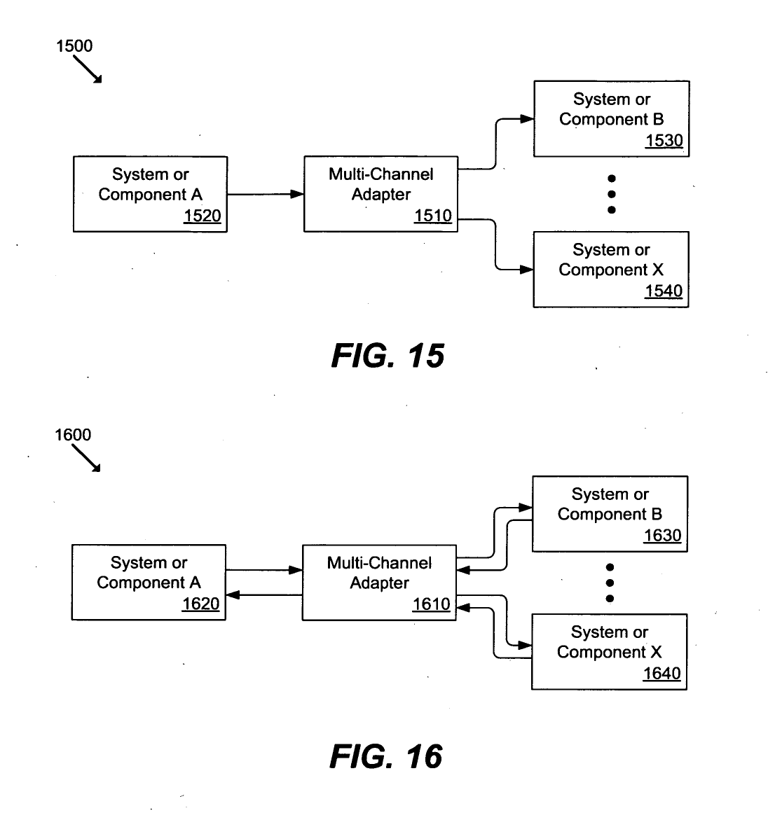

In contrast to the single-channel connections described above in reference to FIGS. 11-14, a MCC may be a connection that allows multiple data sources and/or or data sinks. Example MCCs are described below in reference to FIGS. 15-16.

B. Multi-Channel Connections

FIG. 15 illustrates a conceptual simplex multi-channel connection diagram 1500 of some embodiments. As shown, a multi-channel adapter 1510 is connected to a first system or component 1520 and one or more other systems or components 1530-1540.

FIG. 16 illustrates a conceptual duplex multi-channel connection diagram 1600 of some embodiments. As shown, a multi-channel adapter 1610 is connected to a first system or component 1620 and one or more other systems or components 1630-1640.

A MCC provides for the ability to transparently manage one or more connection instances. For example, a single adapter may have on its output interface a single MCC that, from the perspective of the adapter, operates just as any other connection instance does. However, in actuality, the MCC may manage a set of connection instances that communicate data to a legacy system.

The usefulness of this approach can be demonstrated by considering a single enterprise XML message that includes three separate pieces of information. A legacy system may have been designed to receive these three items with different components and/or interfaces. Thus, the enterprise message must be segmented and routed appropriately. Such a “fan out” operation is supported by NCALS through the judicious specialization of the MCC. Each sub-connection of the MCC includes a transform that may be able to parse the enterprise message, extract the appropriate portion and mutate and format the data to comply with any legacy system requirements. Finally, each sub-connection manages the physical transfer of data whether to a file, an API call, a JMS message, a TCP Socket, etc.

In addition to the fan out scheme described above in reference to FIGS. 15-16, an MCC may similarly support a “fan in” operation. In such an instance, a set of sources of data are aggregated on the input side of the adapter, transformed into a single message, and then sent by the output connection.

C. Multi-Channel Blocking and Non-Blocking Connections

The input style of MCC may have multiple data sources that are able to produce data both synchronously and asynchronously. Some coordination may need to be applied as those messages are received such that they may be assembled and transformed into a single message on the output side of the adapter. An MCC may be configured to be “blocking” in that the MCC will wait for data to be produced on all of its sub-connections prior to assembling and transforming those messages into a single output message.

In a “non-blocking configuration” an MCC may transform messages as the messages are produced and arrive at the connection. If necessary, stubs or placeholders may be placed in the composite message until the component or system responsible for supplying the data. For example, an XML document may be the desired aggregate result on the output side of an adapter, and for sections of the XML document that have not been received from their respective producers, empty elements may hold the place for that data. The specialization of the MCC may optionally store messages and assemble or build an output message as sub-connections produce data. The default behavior for a non-blocking MCC may be defined so as to transform and send data from each sub-connection as it arrives.

D. Configuration Strategies

Many legacy systems include several subcomponents, where each subcomponent may have a specialized interface to other components and/or subcomponents. When implementing a design using NCALS, an LSD must determine how to partition and map the workload of connection and data transformation to NCALS adapters and NCALS connections. Each adapter may be capable of managing a single logical chunk of data flowing either into the adapter and destined for the legacy system or flowing from the legacy system back into the adapter. Generally, each logical chunk of data should be processed by a single adapter.

One approach is to instantiate one or more single adapters and configure each with a MCC. The MCC may manage multiple connection instances (including other MCCs) and may use blocking or non-blocking behavior. This approach is valid when there is timing or content dependency to or from the targeted legacy system components, when a data chunk is being assembled from multiple sources (i.e., fan in), or when a single data chunk is being disassembled into smaller chunks (i.e., fan out).

Another approach is to use one adapter for each content chunk, with each adapter having its own input and output single-channel connection. This approach is valid if various messages are flowing to and from a legacy system, but no timing or content dependencies exist among the messages or data of concern. This approach, because of its inherent simplicity, ease of deployment and configuration, scalability, and natural problem domain partitioning may be preferred when there are no timing or content dependencies among the various data and messages being routed to and from the legacy system.

Another possible configuration is adapter chaining, where multiple adapters are configured such that the output from one adapter becomes the input to another (i.e., a set of two or more adapters may be connected in series). This approach may be useful for applications such as transactional processes as well as performing filtering and multiple pass data processing.

Some embodiments may provide the capability to design, configure and deploy multiple adapters that coordinate among themselves. Such an approach provides redundancy, failover, and load balancing for adapters used in mission critical systems. Load balancing may be useful in supporting very complex data transformations and/or algorithms that operate on the data in more complex ways, as well as operating in a congested network environment.

A complex transform may inhibit throughput and increase latency beyond acceptable limits. Multiple adapters similarly configured may be able to coordinate to alleviate this problem. Because each message may have to be transformed, self-monitoring and inter-adapter communication may be used to level the computational load associated with transforming data.

Network dynamics may contribute to a particular channel being over-utilized. By deploying similarly configured adapters on different subnets, network traffic prior to the legacy system node may be more efficiently routed in some situations.

E. Hosted Adapter Instances

A single JVM may instantiate multiple adapters. Deploying adapters in this manner may be desirable because of hardware constraints or cost, or physical constraints such as space or power. However, each adapter may consume memory and CPU. Scalability with this approach may be a concern.

The adapter manager user interface utilizes hosted adapter instances in order to allow for graphical configuration, instantiation, deployment, administration, and diagnostics of multiple adapter instances within a single JVM.

To address issues of scalability, administration, and redundancy, adapter instances may be deployed across multiple nodes and run in separate JVMs.

### VII. Network Access and Information Assurance

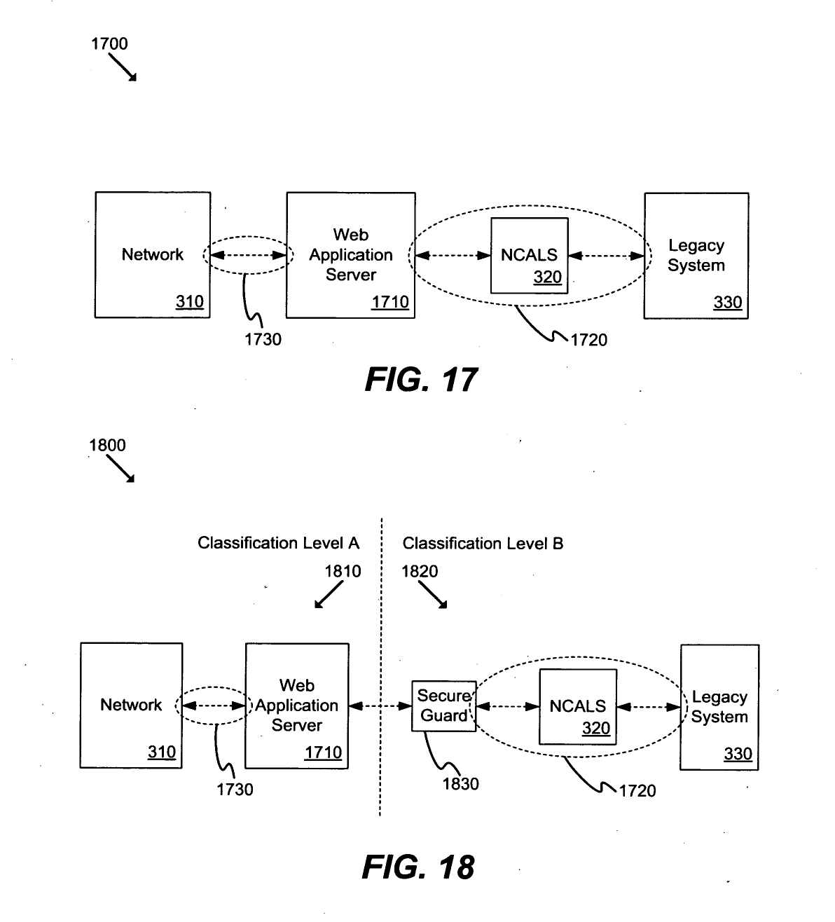

NCALS may be coupled with a web server and/or with a “secure guard” (for information assurance). Such a secure guard may include a combination of one or more firewalls, various encryption/decryption components and/or algorithms, and/or other similar ways of managing access. FIG. 17 illustrates an example conceptual system 1700 where NCALS 320 is coupled to the network 310 through a web application server 1710. As shown, NCALS may communicate with a legacy system 330 and the web application server through a local area network (LAN) 1720. In addition, the web application server may communicate with the network through a second LAN 1730. NCALS may be configured to support a number of different standard technologies used by web servers, including plain web services, the SOAP web service protocol, and the topic-based JMS.

FIG. 18 illustrates an example conceptual system 1800 that includes components and/or data with a first classification level 1810 and other components and/or data with a second classification level 1820. As shown, NCALS 320 may communicate with a secure guard 1830 that facilitates information assurance. In this example, the secure guard is placed between the web application server 1710 and NCALS 320. In this manner, users, systems, components, etc. having a first classification level are not able to access a particular legacy system 330 through NCALS without first passing through the secure guard 1830.

### VIII. Adapter Creator for Distributed Components

The Adapter Creator for Distributed Components (ACDC) may be an enhancement to the adapter manager described above in reference to FIGS. 5-7. The ACDC may automate the design, generation and deployment of complex adapters. To that end, ACDC may provide a GUI-based design environment for adapters, and also integrate with existing SCATs, Code Generation Tools (CGTs), and/or Integrated Development Environments (IDEs) for software.

The ACDC may provide functionality such as a GUI used to display legacy source code analysis results, view and navigate models of legacy software components, enable design of adapters for use in integrating disparate software/systems, and/or display source code search results. The ACDC may also be able to initiate searches of legacy source code, design adapter software, create Unified Modeling Language (UML) models of adapter software, and/or initiate generation of adapter source code.

Sub-section VIIIA below describes the use of the ACDC to generate adapter source code from legacy source code. Sub-section VIII.B then describes the source code analysis performed by some embodiments. Finally, sub-section VIII.C describes example GUI elements that may be used by some embodiments.

A. Generation of Adapter Source Code Using Legacy Source Code

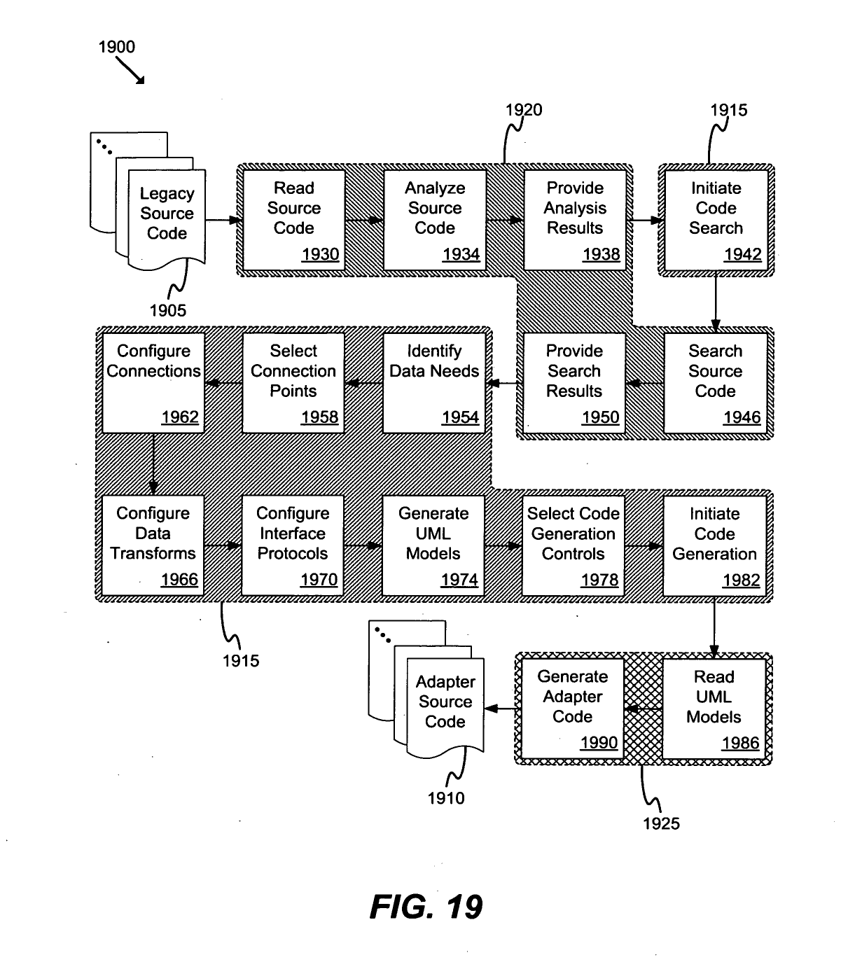

FIG. 19 illustrates a conceptual process 1900 performed by some embodiments to automatically utilize legacy source code 1905 to generate adapter source code 1910. Various operations may be directly performed by the ACDC 1915. In addition, the ACDC may direct other components, such as a SCAT 1920 and/or a CGT 1925 to perform other operations.

In the example process 1900, the SCAT (also known as a reverse engineering tool) may read (at 1930) and analyze (at 1934) the source code (i.e., the implemented architecture) of multiple legacy (or other existing) systems written in one or more programming languages. The results of this legacy architectural analysis may be provided (at 1938) to ACDC.

The architectural analysis results include content and structural information derived from and traceable to the legacy source code. These results may be provided using a standard format (e.g., XML Metadata Interchange (XMI)) or a format unique to a particular SCAT.

When a user elects to search the legacy source code, the ACDC may initiate (at 1942) a code search by sending search commands to the SCAT 1920. The SCAT may then search (at 1946) the source code before providing (at 1950) search results that are received by the ACDC. Such an implementation allows an ACDC user to conduct searches of source code using, for example, domain-specific keywords.

To create one or more adapters, the ACDC assists a user in identifying (at 1954) the data needs of the user's integration problem and finding corresponding data sources and destinations in the legacy software. The ACDC may allow a user to select (at 1958) various connection points (or software interfaces) in the legacy software, configure (at 1962) the type of legacy connections (e.g., an API, CORBA interface, and/or a web service), configure (at 1966) transforms to be applied to the data between its source(s) and destination(s), and configure (at 1970) any interface protocols to be used (e.g., TCP, UDP, and/or a serial interface). Based at least partially on these selections, the ACDC may then generate (at 1974) software models for the adapter software in an appropriate format to be passed to the CGT (e.g., the UML modeling notation).

The ACDC may allow the user to select (at 1978) various controls for code generation. Such controls may include ways of receiving adapter configuration information, desired programming language, etc. Next, the process may initiate (at 1982) code generation, where the ACDC may provide the software models and/or various code generation controls to the CGT 1925. The CGT may then read (at 1986) the models, and, based on the models and code generation controls, the CGT may then generate (at 1990) adapter source code 1910 in the selected programming language(s).

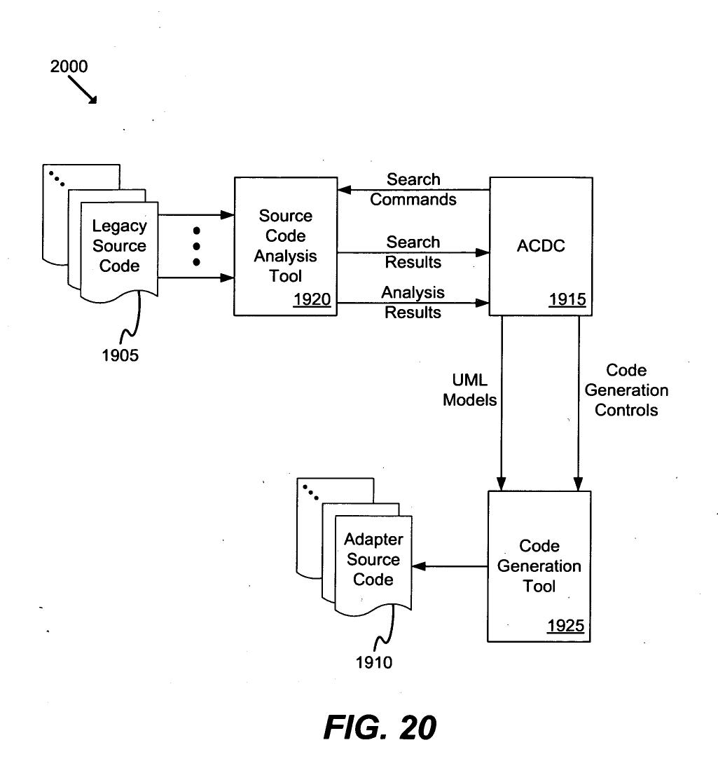

FIG. 20 illustrates a conceptual implementation 2000 that integrates an ACDC 1915 with a SCAT 1920 and CGT 1925. Note that the functions of a SCAT and CGT may be implemented in an IDE for software.

B. Source Code Analysis

The source code analysis results provided by a SCAT to the ACDC represent the structure, interface(s) and data of legacy source code. XMI is one standard output format that can convey this information. The XMI output may relate much of this information using UML constructs.

The analysis results may include information regarding systems, constituent software components, and software interfaces. Example information includes system name, software component metadata and programming language, and/or interface name, access type (e.g., public or private), connection type (e.g., API, CORBA, web service, etc.), interface type (data access, service invocation, etc.), and/or interface definition including a set of data elements.

Such analysis results are based on various identifiable aspects of adapter software. For instance, a software-intensive system may be composed of one or more software components (e.g., the UML “package” modeling construct may be used). A software component may have attributes that include the programming language(s) in which the component is written. A software component may have sub-components. A software component may have one or more interfaces available to other software components and systems.

Such a software interface may have several attributes, including: name, public or private access, access type, interface type, and an interface definition. The access type may categorize the way the interface provides for invoking its software component's services, accessing its data, or providing data to it. Some example categories include: API, CORBA, Web Service, DDS, File, and SQL. An access type may have one or more associated interface protocols (e.g., HTTP, SOAP, JMS, file, RS-232, etc.). A file may have an associated format (e.g., XML, structured text, binary, Hyper Text Markup Language (HTML), etc.).

An interface definition may have an associated format (e.g., C++API, CORBA IDL, WSDL, etc.), an invocation (i.e., a way to invoke it), and various data elements. Examples of a data element include: an object class, a text string, and a 32-bit integer. A data element may have a name (e.g., a variable name) and a type (class, etc.). A data element may be composed of various sub-elements (e.g., attributes of an object class). The structure of a system and its software components may be indicated using UML notation. The structure is often hierarchical in nature.

C. GUI Design Views

The ACDC may allow a user to view and navigate the models of multiple legacy systems' software in a hierarchical manner using a GUI. The views may include: system(s), software component(s), software interface(s), data element(s), and/or adapter(s).

An Adapter links two or more software interfaces (all or a subset of data elements) and transforms data types as required to support the transfer of information among various software interfaces.

A single-channel adapter (SCA) links the software interfaces of two or more software components in a single direction. A multi-channel adapter (MCA) links two or more software components in at least two directions. The ACDC GUI may allow a user to graphically define various SCAs and MCAs.

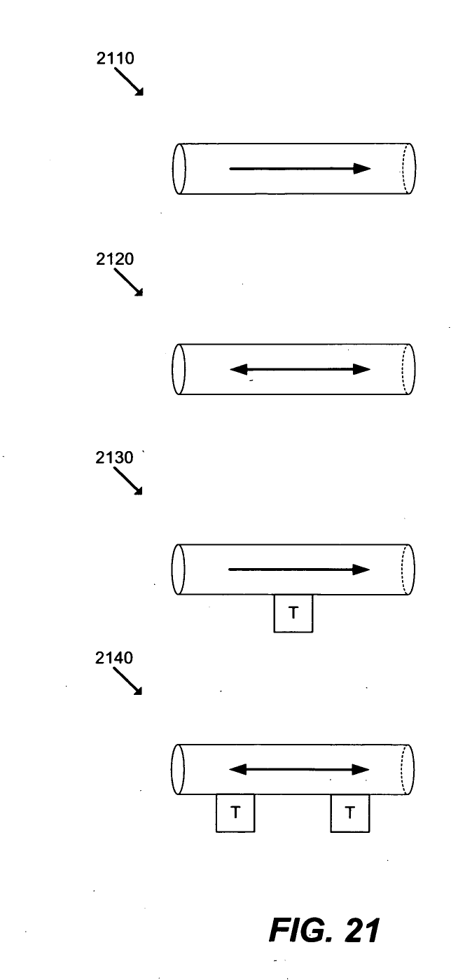

FIG. 21 illustrates various graphical icons 2110-2140 that may be used to denote an adapter in the GUI model of some embodiments. As shown, the figure includes a single-channel adapter 2110, a multi-channel adapter 2120, a single-channel adapter with data transform 2130, and a multi-channel adapter with data transform 2140. The “pipeline” icon indicates single or multi-channel adapters and also whether or not a data transformation is part of the adapter.

Adapters may be defined by several attributes, including: name (user-defined), source interface(s), sink (destination) interface(s), and data transformation(s).

The ACDC user can define a data transformation in detail when identified or defer the details (e.g., by retaining default values provided by the ACDC). A library of data transformations (DTs) may be provided by the ACDC, allowing the user to choose to reuse pre-defined or user-defined DTs, create new DTs, and/or modify/save DTs.

Once a user defines one or more adapters, the user may generate a UML model of the adapter software. Such an adapter software model may then be provided to a source code generation tool, along with other information (e.g., programming language) needed to generate the adapter source code. The ACDC may also include textual data (e.g., comments), metadata, documentation, and/or other data with the adapter software.

### IX. Computer System

Many of the processes and modules described above may be implemented as software processes that are specified as a set of instructions recorded on a computer readable storage medium (also referred to as “computer readable medium” or “machine readable medium”). When these instructions are executed by one or more computational element(s), such as processors or other computational elements like Application-Specific ICs (“ASIC”) and Field Programmable Gate Arrays (“FPGA”), they cause the computational element(s) to perform the actions indicated in the instructions.

Computer is meant in its broadest sense, and can include any electronic device with at least one processor. Examples of computer readable media include, but are not limited to, CD-ROMs, flash drives, RAM chips, hard drives, EPROMs, etc. The computer readable media do not include carrier waves and/or electronic signals passing wirelessly or over a wired connection.

In this specification, the term “software” includes firmware residing in read-only memory or applications stored in magnetic storage which can be read into memory for processing by one or more processors. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described herein is within the scope of the invention. In some embodiments, the software programs when installed to operate on one or more computer systems define one or more specific machine implementations that execute and perform the operations of the software programs.

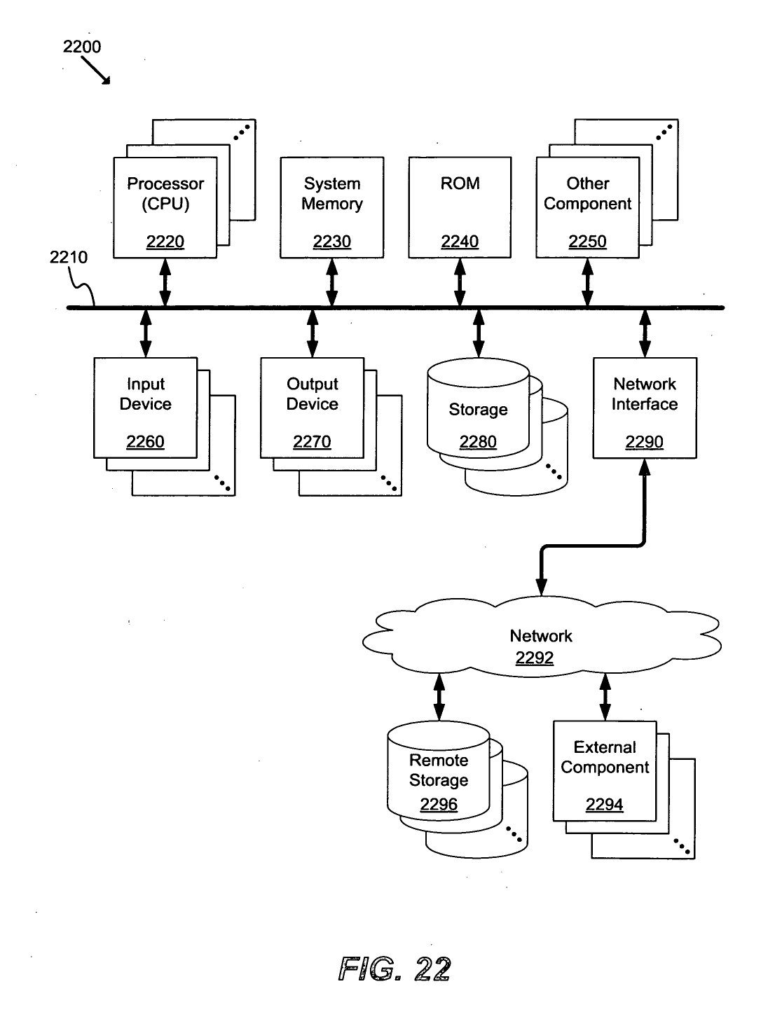

FIG. 22 conceptually illustrates a computer system 2200 with which some embodiments of the invention are implemented. For example, the system described above in reference to, for example, FIGS. 3-5 may be at least partially implemented using computer system 2200. As another example, the processes described in reference to FIGS. 6, 7, and 19 may be at least partially implemented using sets of instructions that are run on the computer system 2200.

Such a computer system includes various types of computer readable media and interfaces for various other types of computer readable mediums. Computer system 2200 includes a bus 2210, at least one processing unit (e.g., a processor) 2220, a system memory 2230, a read-only memory (ROM) 2240, other components (e.g., a graphics processing unit or GPU) 2250, input devices 2260, output devices 2270, permanent storage devices 2280, and one or more network interfaces 2290. The components of the computer system 2200 are electronic devices that automatically perform operations based on digital and/or analog input signals. The various examples of user interfaces shown in FIG. 21 may be at least partially implemented using sets of instructions that are run on the computer system 2200 and displayed using the output devices 2270.

One of ordinary skill in the art will recognize that the computer system 2200 may be embodied in other specific forms without deviating from the spirit of the invention. For instance, the computer system may be implemented using various specific devices either alone or in combination. For example, a local PC may include the input devices 2260 and output devices 2270, while a remote PC may include the other devices 2210-2250 and 2280, with the local PC connected to the remote PC through a network that the local PC accesses through its network connection 2290 (where the remote PC is also connected to the network through a network connection).

The bus 2210 represents all communication pathways that connect the numerous devices of the computer system 2200. Such pathways may include wired, wireless, and/or optical communication pathways. For example, the input devices 2260 and/or output devices 2270 may be coupled to the system 2200 using a wireless local area network (W-LAN) connection, Bluetooth®, or some other wireless connection protocol or system.

The bus 2210 communicatively connects, for example, the processor 2220 with the system memory 2230, the ROM 2240, and the permanent storage device 2280. From these various memory units, the processor 2220 retrieves instructions to execute and data to process in order to execute the processes of some embodiments. In some embodiments the processor includes an FPGA, an ASIC, or various other electronic components for execution instructions.

The ROM 2240 stores static data and instructions that are needed by the processor 2220 and other modules of the computer system. The permanent storage device 2280, on the other hand, is a read-and-write memory device. This device is a non-volatile memory unit that stores instructions and data even when the computer system 2200 is off. Some embodiments of the invention use a mass-storage device (such as a magnetic or optical disk and its corresponding disk drive) as the permanent storage device 2280.

Other embodiments use a removable storage device (such as a floppy disk, flash drive, or CD-ROM) as the permanent storage device. Like the permanent storage device 2280, the system memory 2230 is a read-and-write memory device. However, unlike storage device 2280, the system memory 2230 is a volatile read-and-write memory, such as a random access memory (RAM). The system memory stores some of the instructions and data that the processor needs at runtime. In some embodiments, the sets of instructions and/or data used to implement the invention's processes are stored in the system memory 2230, the permanent storage device 2280, and/or the read-only memory 2240. For example, the various memory units include instructions for generating adapters in accordance with some embodiments.

In addition, the bus 2210 may connect to various other components 2250. In some embodiments, the other components may include a GPU that is able to perform various graphics processing functions. These functions may include display functions, rendering, compositing, and/or other functions related to the processing or display of graphical data.

The bus 2210 also connects to various input devices 2260 and output devices 2270. The input devices 2260 enable the user to communicate information and select commands to the computer system. The input devices include alphanumeric keyboards and pointing devices (also called “cursor control devices”). The input devices also include audio input devices (e.g., microphones, MIDI musical instruments, etc.) and video input devices (e.g., video cameras, still cameras, optical scanning devices, etc.). The output devices 2270 include printers, electronic display devices that display still or moving images, and electronic audio devices that play audio generated by the computer system. For instance, these display devices may display a graphical user interface (GUI). The display devices include devices such as cathode ray tubes (CRT), liquid crystal displays (LCD), plasma display panels (PDP), surface-conduction electronemitter displays (alternatively referred to as a “surface electron display” or SED), etc. The audio devices include a PC's sound card and speakers, a speaker on a cellular phone, a Bluetooth® earpiece, etc. Some or all of these output devices may be wirelessly or optically connected to the computer system.

Finally, as shown in FIG. 22, bus 2210 also couples computer system 2200 to a network interface 2290 that may be used to access one or more networks 2292. In this manner, the computer can be a part of a network of computers (such as a local area network (LAN), a wide area network (WAN), an Intranet, or a network of networks, such as the Internet. For example, the computer 2200 may be coupled to a web server (through network 2292) so that a web browser executing on the computer 2200 can interact with the web server as a user interacts with a GUI that operates in the web browser. The computer system 2200 may access various external components 2294 and/or remote storages 2296 through the network interface 2290.

As mentioned above, some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable blu-ray discs, ultra density optical discs, any other optical or magnetic media, and floppy disks. The computer-readable media may store a computer program that is executable by a device such as an electronics device, a microprocessor, a processor, a multi-processor (e.g., an IC with several processing units on it) and includes sets of instructions for performing various operations. The computer program excludes any wireless signals, wired download signals, and/or any other ephemeral signals.

Examples of hardware devices configured to store and execute sets of instructions include, but are not limited to, ASICs, FPGAs, programmable logic devices (“PLDs”), ROM, and RAM devices. Examples of computer programs or computer code include machine code, such as produced by a compiler, and files including higher-level code that are executed by a computer, an electronic component, or a microprocessor using an interpreter.

As used in this specification and any claims of this application, the terms “computer”, “server”, “processor”, and “memory” all refer to electronic or other technological devices. These terms exclude people or groups of people. For the purposes of this specification, the terms display or displaying mean displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and/or any other ephemeral signals.

It should be recognized by one of ordinary skill in the art that any or all of the components of computer system 2200 may be used in conjunction with the invention. Moreover, one of ordinary skill in the art will appreciate that any other system configuration may also be used in conjunction with the invention or components of the invention.

Moreover, while the examples shown illustrate many individual modules as separate blocks (e.g., the connection, the transform, etc.), one of ordinary skill in the art would recognize that some embodiments may combine these modules into a single functional block or element. One of ordinary skill in the art would also recognize that some embodiments may divide a particular module into multiple modules.

It should be understood, of course, that the foregoing relates to preferred embodiments of the invention and that modifications may be made without departing from the spirit and scope of the invention as set forth in the following claims.

The invention claimed is:

1. A configurable adapter system operating on a non-transitory computer platform for translating, exchanging and integrating data and services among disparate software applications including an adapter between a legacy system and a global information grid (GIG), said adapter comprising:
a web application server that connects to the GIG through a first network;
an adapter interface module that connects to the legacy system and to said web application server through a second network;
a first connection that interfaces said web application server with said adapter interface module in said second network;
a second connection that interfaces said adapter interface module with the legacy system through said second network; and
a third connection that interfaces said web application server with the GIG in said first network, wherein
said adapter interface module receives initial data from legacy one of the legacy system via said second connection and the GIG via said first connection, transforms said initial data into transfer data, and passes said transfer data to the other of the legacy system and the GIG.

2. The system of claim 1, wherein the adapter further includes a transform module associated with said adapter interface module for transforming said initial data.

3. The system of claim 2, wherein said transform module is a plug-in module.

4. The system of claim 1, wherein said adapter interface module further includes:
a source code analysis tool (SCAT) for reading source code from the legacy system, analyzing said source code, and searching said source code, and
a code generation tool (CGT) for identifying data requirements, selecting connection nodes, configuring connections, configuring data transformations, configuring interface protocols, generating unified modeling language (UML) models, selecting code generation controls and initiating code generation for said adapter interface module.

5. The system of claim 1, wherein said adapter interface module comprises a plurality of channels.

6. The system of claim 5, wherein each channel of said second connection of said adapter interface module interfaces with a different legacy system.

7. The system of claim 6, wherein said adapter interface module converts messages received from a plurality of legacy systems into a single message readable by the GIG.

8. The system of claim 7, wherein said adapter interface module sends a complete message to the GIG after messages have been received from all of said plurality of legacy systems.

9. The system of claim 6, wherein said adapter interface module converts a single message received from the GIG into a set of sub-messages, each sub-message readable by a distinct legacy system.

10. The system of claim 4, wherein said adapter interface module further includes operations for code search initiation, UML model reading and adapter code generation performed by an application specific integrated circuit (ASIC).

11. The system of claim 1, further comprising:
a security module that connects to said adapter interface module through said second network via said first connection; and
a fourth connection that interfaces said web application server with said adapter interface module, wherein said security module is separated from said web application server by classification level.

12. The system of claim 1, wherein the adapter among a plurality of adapter interface modules.

13. The system of claim 1, wherein a set of adapters is connected in series such that at least one second connection of a first adapter is coupled to at least one first connection of another adapter.

14. An automated method of configuring each of a plurality of adapters used to interface among a plurality of systems, the method comprising:
receiving, through the adapter manager, a selection of a transform type;
receiving, through the adapter manager, a selection of an output interface connection type; and
configuring an adapter based at least partially on the input interface connection type, the transform type and the output interface connection type.

15. The method of claim 14 further comprising receiving a selection of at least one of simplex operation and duplex operation, the adapter further configured at least partially based on the selection.

16. The method of claim 14, wherein at least one of the input interface connection type, the output interface connection type, and the transform type is a user-defined type allowing extensibility user-developed system components.

17. The method of claim 14, wherein receiving a selection of an input interface connection type comprises presenting, through a graphical user interface, a plurality of input interface connection controls and receiving a user selection.

18. The method of claim 14, wherein the input interface connection type is adapted to interface to at least one of a Transmission Control Protocol (TCP), Internet Protocol (IP), User Datagram Protocol (UDP), web service, Simple Object Access Protocol (SOAP), Data Distribution Service (DDS), Common Object Request Broker Architecture (CORBA), RSS feed, email, Hyper Text Markup Language (HTML), Hypertext Transfer Protocol (HTTP), file, Comma Separated Values (CSV), serial interface, Java Message Service (JMS), Representational State Transfer (REST), and socket-based application programming interface (API).

19. The method of claim 14, wherein receiving a selection of a transform type comprises presenting, through a graphical user interface, a plurality of transform controls and receiving a user selection.

20. The method of claim 14, wherein receiving a selection of an output interface connection type comprises presenting, through a graphical user interface, a plurality of output interface connection controls and receiving a user selection.

21. The method of claim 14, wherein the output interface connection type is adapted to interface to at least one of a Transmission Control Protocol (TCP), Internet Protocol (IP), User Datagram Protocol (UDP), web service, Simple Object Access Protocol (SOAP), Data Distribution Service (DDS), Common Object Request Broker Architecture (CORBA), RSS feed, email, Hyper Text Markup Language (HTML), Hypertext Transfer Protocol (HTTP), file, Comma Separated Values (CSV), serial interface, Java Message Service (JMS), Representational State Transfer (REST), and socket-based application programming interface (API).

22. The method of claim 14 further comprising receiving a set of configuration parameters, where the operation of the input interface connection is at least partially based on the configuration parameters.

23. The method of claim 14 further comprising receiving a set of configuration parameters, where the operation of the output interface connection is at least partially based on the configuration parameters.

24. A computer readable media for automatically generating adapter source code from existing source code, the computer readable media comprising:
a code segment for directing analysis of the existing source code;
a code segment for configuring a set of connections based on the analysis of the existing source code; and
a code segment for initiating code generation of the adapter source code using a code generation tool, the code generation being at least partially based on the analysis of the existing source code and configuration of the set of connections.

25. The computer readable media of claim 24 further comprising a code segment for configuring a set of data transforms associated with the set of connections, the code generation being at least partially based on the configuration of the set of data transforms.

26. The computer readable media of claim 24 further comprising a code segment for configuring a plurality of interface protocols, the code generation being at least partially based on the configuration of the interface protocols.

27. The computer readable media of claim 24 further comprising a code segment for generating a set of software models that are receivable and processable by the code generation tool.

28. The computer readable media of claim 27, wherein the software models are Unified Modeling Language (UML) models.

29. The computer readable media of claim 24 further comprising a code segment for allowing selection of a set of connection points.
